(19) United States
(12) Patent Application Publication
(10) Pub. No.: US 2003/0197601 A1
(43) Pub. Date: Oct. 23, 2003

(54) Collision preventing device for vehicle

(76) Inventors: Kunio Takagi, Kanagawa-ken (JP); Yasuo Kotera, Kanagawa-ken (JP)

Correspondence Address: Brinks Hofer Gilson & Lione, P.O. Box 10395, Chicago, IL, 60610, US

(21) Appl. No.: 10/409,325

(22) Filed: Apr. 8, 2003

(30) Foreign Application Priority Data
Apr. 18, 2002 (JP) 2002-116665

(51) Int. Cl. B60Q 1/00

(52) U.S. Cl. 340/435; 340/407.1

(57) ABSTRACT

An obstacle preventing device includes an obstacle detecting sensor, a steering wheel, a vibrator secured to the steering wheel, a controller for controlling driving of the vibrator, and a vehicle velocity detecting sensor. When the distance between a vehicle body and an obstacle becomes equal to a predetermined threshold distance, the controller outputs a drive signal to the vibrator in order to vibrate the steering wheel by the vibrator.

### BACKGROUND OF THE INVENTION

1. Field of the Invention

The present invention relates to a collision preventing device for a vehicle, and, more particularly, to means for warning a driver by exerted force.

2. Description of the Related Art

Conventionally, a vehicle collision preventing device, comprising at least one obstacle detecting sensor and a speaker that are disposed at a vehicle body, for generating a warning sound by the speaker when ah obstacle is detected by the at least one obstacle detecting sensor is known.

When this collision preventing device is provided, since a warning sound is generated by the speaker when the vehicle body moves close to an obstacle, the driver is made to pay attention to the obstacle, thereby making it easier for the driver to avoid collision.

However, in the vehicle, the noise of the engine and exhaust noise are transmitted into the inside of the vehicle and there are times when people are engaging in conversation, or are listening to the radio or using an audio device. When it is not quiet inside the vehicle, it is difficult for the driver to hear the warning sound, thereby making it difficult for the driver to avoid collision.

### SUMMARY OF THE INVENTION

The present invention has been achieved to overcome the aforementioned problem of the related art, and has as its object the provision of a vehicle collision preventing device which can reliably warn a driver that he is approaching an obstacle by exerted force in order to more reliably prevent collision with the obstacle.

To this end, according to the present invention, there is provided a vehicle collision preventing device comprising at least one obstacle detecting sensor disposed at a vehicle body; at least one actuator for exerting outside force upon any inside equipment with which the body of a driver contacts when driving; and controlling means for controlling driving of the at least one actuator. In the vehicle collision preventing device, when the at least one obstacle detecting sensor detects an obstacle, the controlling means repeatedly calculates the distance between the vehicle body and the obstacle, so that, when the calculated distance between the vehicle body and the obstacle has become equal to a threshold distance previously set in the controlling means, the controlling means drives the at least one actuator to exert the outside force upon the any inside equipment.

Accordingly, in the structure comprising at least one obstacle detecting sensor, at least one actuator, and controlling means at the vehicle, when the at least one obstacle detecting sensor detects an obstacle and the controlling means determines that the distance to the obstacle from the vehicle body has become equal to a previously set threshold distance, the controlling means controls the driving of the at least one actuator. When the controlling operation causes an outside force to be applied to any inside equipment, the driver can realize that he is approaching an obstacle by exerted force. Therefore, regardless of the loudness of the noise inside the vehicle, the driver can reliably realize that he has approached the obstacle, and, thus, reliably prevent collision with the obstacle.

In a first form, in accordance with the calculated distance between the vehicle body and the obstacle, the controlling means changes the outside force exerted upon the any inside equipment by the at least one actuator.

Accordingly, in the case where outside force exerted upon any inside equipment by the at least one actuator is varied in accordance with the vehicle-to-obstacle distance calculated by the controlling means, when, for example, the outside force exerted upon any inside equipment by the at least one actuator is increased as the vehicle-to-obstacle-distance decreases, the driver can realize how close he is to colliding with the obstacle, and, thus, reliably prevent collision with the obstacle.

In a second form, the controlling means determines the position of the obstacle with respect to the vehicle body and, in accordance with the determined position of the obstacle with respect to the vehicle body, changes the outside force exerted upon the any inside equipment by the at least one actuator.

Accordingly, in the case where outside force exerted upon any accessory by the at least one actuator is varied in accordance with the position of the obstacle with respect to the vehicle body, when, for example, there is an obstacle on the right side of the vehicle body, driving force of the actuator on the right side of the driver's seat is increased, whereas, when there is an obstacle on the left side of the vehicle body, driving force of the actuator on the left side of the driver's seat is increased. By this, the driver can know the position of the obstacle with respect to the vehicle body, and, thus, reliably prevent collision with the obstacle.

In a third form, the vehicle collision preventing device further comprises a vehicle velocity detecting sensor for detecting the velocity of the vehicle, wherein, based on a velocity signal output from the vehicle velocity detecting sensor, the controlling means changes the outside force exerted upon the any inside equipment by the at least one actuator.

Collision between a vehicle and an obstacle tends to occur the higher the velocity of the vehicle. Therefore, in the structure comprising a vehicle velocity detecting sensor, in the case where outside force exerted upon any inside equipment by the at least one actuator is changed based on a velocity signal output from the vehicle velocity detecting sensor, when, for example, the outside force exerted upon any inside equipment by the at least one actuator is increased as the velocity of the vehicle increases, the driver can realize how close he is to colliding with the obstacle, and, thus, reliably prevent collision with the obstacle.

In a fourth form, the collision preventing device for a vehicle further comprises a steering angle detecting sensor for detecting the steering angle of a steering wheel, wherein, based on a steering angle signal output from the steering angle detecting sensor, the controlling means changes the outside force exerted upon the any inside equipment by the at least one actuator.

When there is an obstacle beside the vehicle body, collision between the vehicle and the obstacle tends to occur the larger the steering angle of the steering wheel. Therefore, in the structure comprising a steering angle detecting sensor, in the case where outside force exerted upon any inside equipment by the at least one actuator is varied based on a steering angle signal output from the steering angle detecting sensor, when, for example, the outside force exerted upon any inside equipment by the at least one actuator is increased as the angle of the steering wheel increases, the driver can realize how close he is to colliding with the obstacle, and, thus, reliably prevent collision with the obstacle.

In a fifth form, the collision preventing device for a vehicle further comprises a steering angle detecting sensor for detecting the steering angle of a steering wheel and a travel direction detecting sensor for detecting the direction of travel of the vehicle, wherein, based on a steering angle signal output from the steering angle detecting sensor and a travel direction signal output from the travel direction detecting sensor, the controlling means changes the outside force exerted upon the any inside equipment by the at least one actuator.

When there is an obstacle beside the vehicle body, collision between the vehicle and the obstacle tends to occur the larger the steering angle of the steering wheel or the higher the velocity of the vehicle. Therefore, in the structure comprising a steering angle detecting sensor and a vehicle velocity detecting sensor, in the case where outside force exerted upon any inside equipment by the at least one actuator is varied based on a steering angle signal output from the steering angle detecting sensor and a traveling direction signal output from the traveling direction detecting sensor, when, for example, the outside force exerted upon any inside equipment by the at least one actuator is increased as the steering angle or the velocity of the steering wheel increase, the driver can realize how close he is to colliding with the obstacle, and, thus, reliably prevent collision with the obstacle.

In a sixth form, the any inside equipment upon which the outside force is exerted by the at least one actuator is any one of a steering shaft, a steering wheel, and a seat.

Since the steering shaft, steering wheel, and seat always directly or indirectly contact the body of the driver when he is driving the vehicle, the driver can reliably feel outside force exerted by the at least one actuator, and, thus, reliably prevent collision with the obstacle.

In a seventh form, when the structure of the sixth form is used, the controlling means exerts the outside force upon the steering shaft by driving the at least one actuator in order to resist steering in the direction of the obstacle.

Accordingly, when the outside force that opposes steering in a direction of the obstacle is exerted upon the steering shaft from the at least one actuator, not only is the driver warned by exerted force about the danger of colliding with the obstacle, but is also automatically prevented from performing a dangerous steering operation. Therefore, the driver can reliably prevent collision with the obstacle.

In an eighth form, when the structure of the sixth form is used, the controlling means drives the at least one actuator in order to vibrate any one of the steering shaft, the steering wheel, and the seat for warning the driver.

Accordingly, when any one of the steering shaft, steering wheel, and seat is subjected to warning vibration by the at least one actuator, the driver can realize that he is in danger of colliding by exerted force, and drive the vehicle in such a way as to avoid collision. Therefore, the driver can reliably prevent collision with an obstacle.

In a ninth form, the at least one obstacle detecting sensor is disposed at a side mirror.

Accordingly, when the at least one obstacle detecting sensor is provided at a side mirror, the range of detection of an obstacle can be changed by driving the side mirror, so that drivers can set a suitable obstacle detection range when they drive the vehicle, so that the collision preventing device can be made more versatile.

In a tenth form, the collision preventing device for a vehicle further comprises a speaker disposed at the vehicle body, wherein, when the at least one obstacle detecting sensor detects the obstacle, the controlling means repeatedly calculates the distance between the vehicle body and the obstacle, so that, when the calculated distance between the vehicle body and the obstacle has become equal to a threshold distance previously set in the controlling means, the controlling means drives the at least one actuator to exert the outside force upon the any inside equipment and drives the speaker to generate a warning sound by the speaker.

Accordingly, when the vehicle collision preventing device is constructed to warn the driver by force exerted by the at least one actuator and sound generated by the speaker, the driver can realize how close he is to colliding with an obstacle, and, thus, reliably prevent collision with the obstacle.

### BRIEF DESCRIPTION OF THE DRAWINGS

FIG. 1 is a diagram showing a first example of obstacle detection ranges and the locations of obstacle detecting sensors of a vehicle collision preventing device of the present invention;

FIG. 2 is a diagram showing a second example of obstacle detection ranges and the locations of obstacle detecting sensors of the vehicle collision preventing device of the present invention;

FIG. 3 is a diagram showing a third example of an obstacle detection range and the location of an obstacle detecting sensor of the vehicle collision preventing device of the present invention;

FIG. 4 illustrates the structure of a collision preventing device of a first embodiment of the present invention;

FIGS. 5A and 5B show graphs of examples of actuator drive data stored in a storage section of controlling means of the collision preventing device of the first embodiment;

FIG. 6 is a flowchart of the steps of the operation of the controlling means of the collision preventing device of the first embodiment;

FIG. 7 is a graph of another example of actuator drive data;

FIG. 8 is a graph of still another example of actuator drive data;

FIG. 9 illustrates the structure of a collision preventing device of another embodiment of the present invention;

FIG. 10 illustrates the structure of a collision preventing device of still another embodiment of the present invention; and

FIG. 11 is a flowchart of the steps of the operation of controlling means of the collision preventing device of the still another embodiment.

### DESCRIPTION OF THE PREFERRED EMBODIMENTS

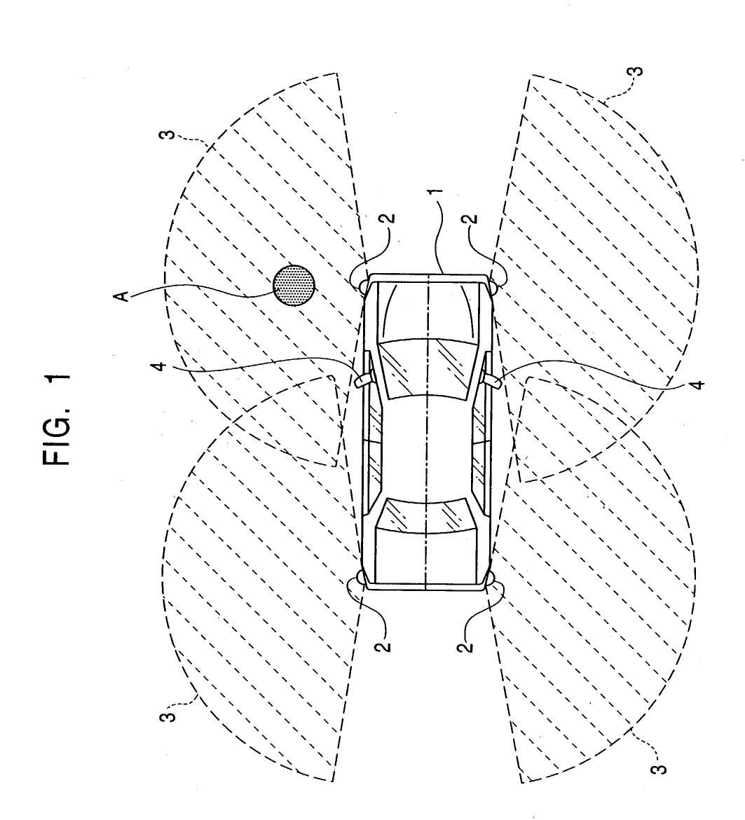

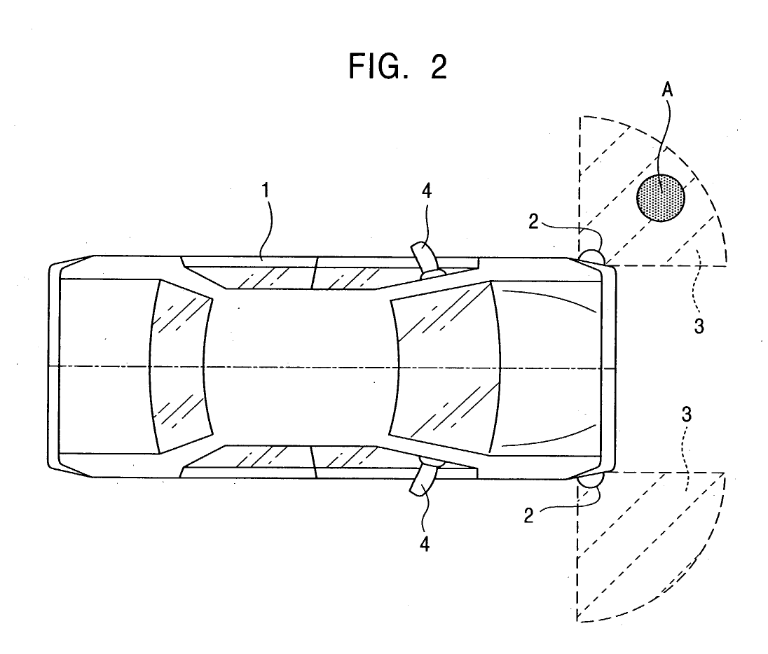

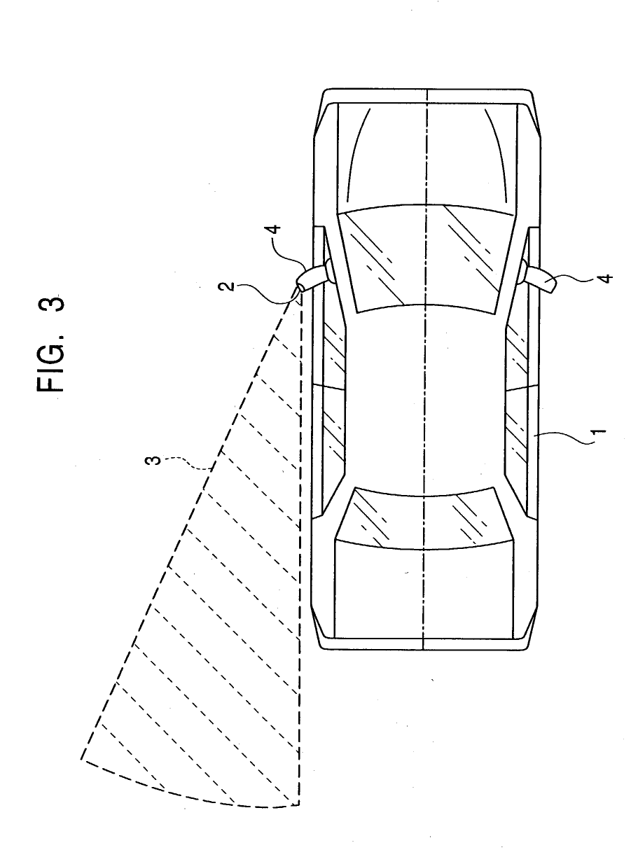

A description of locations of obstacle detecting sensors of a vehicle collision preventing device of the present invention and ranges of detection of an obstacle by the obstacle detecting sensors are given with reference to FIGS. 1 and 2. The location of an obstacle detecting sensor of the vehicle collision preventing device of the present invention and a range of detection of the obstacle by the obstacle detecting sensor is given with reference to FIG. 3. In these figures, reference numeral 1 denotes a vehicle body, reference numeral or numerals 2 denote obstacle detecting sensors, reference numeral or numerals 3 denote obstacle detection ranges of the obstacle detecting sensors 2, reference numerals 4 denote side mirrors, and reference character A denotes an obstacle.

FIG. 1 illustrates an example in which a total of four obstacle detecting sensors 2 is disposed at the right front corner, the left front corner, the right rear corner, and the left rear corner of the vehicle body 1, respectively. As is clear from FIG. 1, in this example, since the obstacle detecting sensors 2 can monitor substantially the whole area surrounding the vehicle body 1, the obstacle A can be detected in any area surrounding the vehicle body 1. Therefore, a collision preventing device which is optimally effective in preventing collision can be constructed.

FIG. 2 illustrates an example in which a total of only two obstacle detecting sensors 2 is disposed at the right front corner and the left front corner of the vehicle body 1. As is clear from FIG. 2, in the example, although the obstacle detection ranges 3 of the obstacle detecting sensors 2 are limited to areas surrounding the right front corner and the left front corner, since fewer obstacle detecting sensors 2 are used, it is possible to provide a lower-cost collision preventing device.

FIG. 3 illustrates an example in which an obstacle detecting sensor 2 is only disposed at the left side mirror 4. As is clear from FIG. 3, in the example, although the obstacle detection range 3 of the obstacle detecting sensor 2 is limited to an area behind the left side mirror 4 of the vehicle body 1, since there is only one obstacle detecting sensor 2, it is possible to provide a lower-cost collision preventing device, and to change the range of detection of the obstacle A by driving the side mirror 4. Therefore, drivers can set a suitable obstacle detection range when they drive the vehicle, so that the collision preventing device can be made more versatile.

The locations and number of obstacle detecting sensors 2 are not limited to those in the examples shown in FIGS. 1 to 3, so that, if necessary, any number of obstacle detecting sensors 2 can be set at any location.

Although the obstacle detecting sensors 2 are of a type that transmits electric waves and receives electric waves reflected by an obstacle, the obstacle detecting sensors 2 may be of any type of the related art, such as a type that transmits infrared rays and receives infrared rays reflected by an obstacle or a type that transmits ultrasonic waves and receives ultrasonic waves reflected by an obstacle.

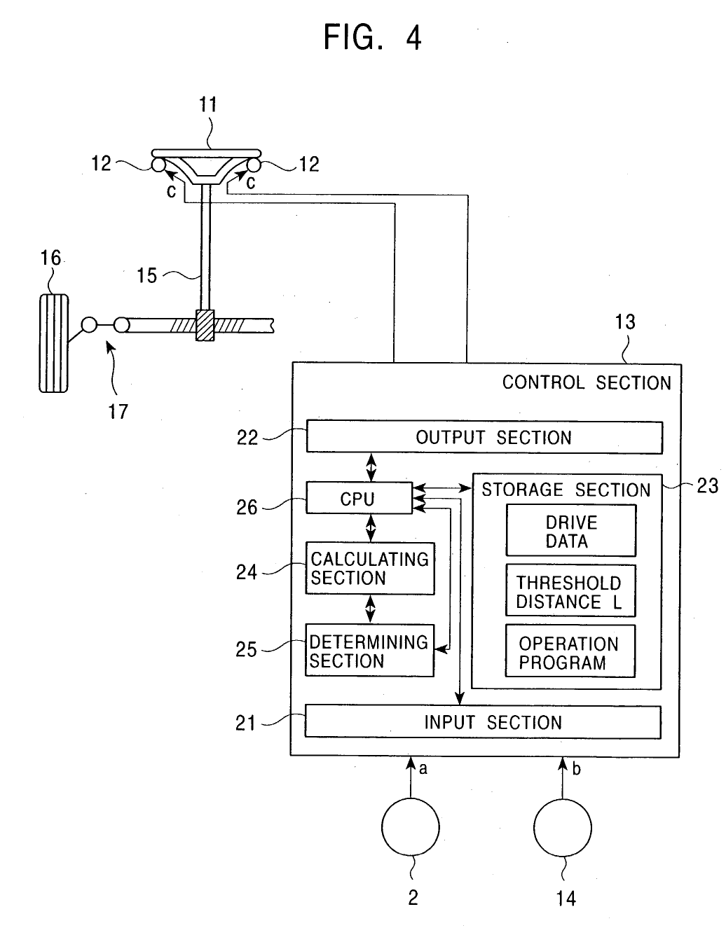

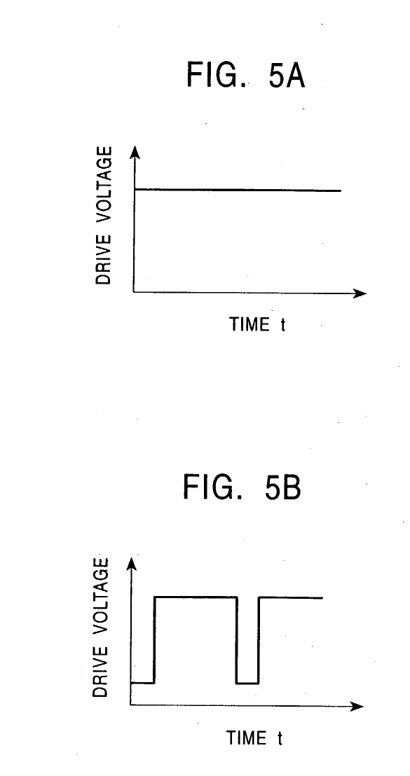

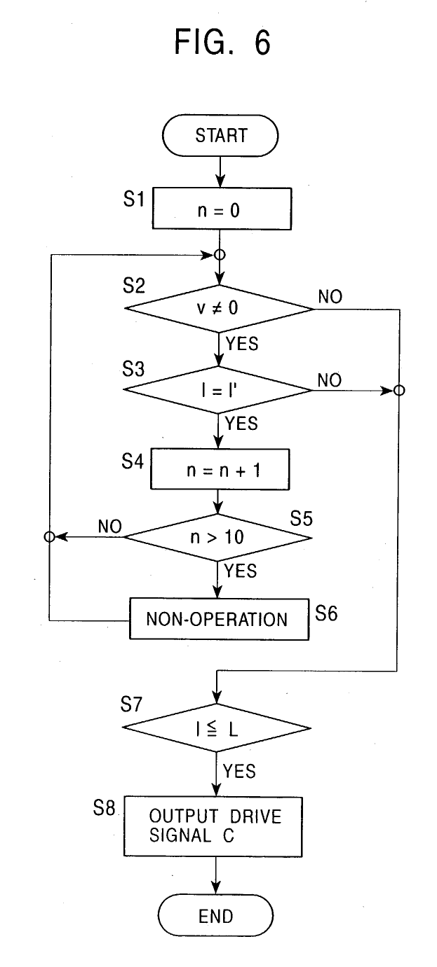

Next, a collision preventing device comprising an obstacle detecting sensor 2 of a first embodiment of the present invention will be described with reference to FIGS. 4 to 6. The most basic structure of the collision preventing device is illustrated in the embodiment. FIG. 4 illustrates the structure of the collision preventing device of the first embodiment of the present invention. FIGS. 5A and 5B show graphs of examples of actuator drive data stored in a storage section of controlling means of the collision preventing device of the embodiment. FIG. 6 is a flowchart of the steps of the operation of the controlling means of the collision preventing device of the first embodiment.

As shown in FIG. 4, the collision preventing device of the embodiment comprises a steering wheel 11, vibrators (actuators) 12 secured to the steering wheel 11, a controller (controlling means) 13 for controlling driving of the vibrators 12, a vehicle velocity detecting sensor 14, and the obstacle detecting sensor 2. In FIG. 4, reference numeral 15 denotes a steering shaft that is rotationally operated by the steering wheel 11, reference numeral 16 denotes a tire, and reference numeral 17 denotes a link mechanism for converting rotational motion of the steering shaft 15 to turning motion of the tire 16.

For the vibrators 12, a type having a decentered heavy weight secured to a rotary shaft of a rotary motor, a type having a heavy weight secured to a drive shaft of a solenoid, or the like, is used. However, the type having a decentered heavy weight secured to a rotary shaft of a rotary motor is desirably used because driving is more easily controlled. In the description below, the vibrators 12 are of a type having a decentered heavy weight secured to a rotary shaft of a rotary motor. When the type having a heavy weight secured to a drive shaft of a solenoid is used, alternating voltage is applied to the vibrators 12. The vibrators 12 are mounted to predetermined locations of the steering wheel 11 either directly or through a diaphragm. When the vibrators 12 are mounted to the predetermined locations of the steering wheel 11 through a diaphragm, vibration (outside force) generated by the vibrators 12 can be amplified, so that, compared to the case where the vibrators 12 are directly mounted to the steering wheel 11, a driver can be more reliably warned by exerted force.

As shown in FIG. 4, the controller 13 comprises an input section 21, an output section 22, a storage section 23, a calculating section 24, a determining section 25, and a central processing unit (CPU) 26 for controlling each of these parts. The obstacle detecting sensor 2 and the vehicle velocity detecting sensor 14 are connected to the input section 21, and the vibrators 12 are connected to the output section 22.

As shown in FIG. 4, the storage section 23 stores drive data of the vibrators 12, the distance between the vehicle body 1 and the obstacle A when application of drive voltage to the vibrators 12 is started, that is, a threshold distance L, and a controller operation program illustrated in FIG. 6. When the vibrators 12 are of a type having a decentered heavy weight secured to a rotary shaft of a rotary motor, the storage section 23 stores, as drive data of the vibrators 12, drive data for applying a constant voltage to the vibrators 12 (as shown in FIG. 5A) and drive data for repeatedly applying constant voltages to the vibrators 12 (as shown in FIG. 5B). It is desirable to repeatedly apply constant voltages to the vibrators 12 because the driver can be more reliably warned by exerted force than when a constant voltage is applied to the vibrators 12.

The calculating section 24 and the determining section 25 fetch obstacle detection data a output from the obstacle detecting sensor 2 through the input section 21 and the CPU 26. The calculating section 24 calculates a distance l between the vehicle body 1 and the obstacle A, and the determining section 25 repeatedly determines whether or not the distance l has become equal to the threshold distance L stored in the storage section 23. In addition, the calculating section 24 and the determining section 25 fetch vehicle velocity data b output from the vehicle velocity detecting sensor 14 through the input section 21 and the CPU 26 in order to repeatedly calculate the vehicle velocity.

Hereunder, a description of the operation of the collision preventing device having the above-described structure will be given with reference to FIG. 6.

First, when an engine is started, the CPU 26 resets the calculating section 24 and the determining section 25, and sets a calculation number n of the calculating section 24 at 0 (Step S1). Next, the CPU 26 causes the calculating section 24 to calculate a vehicle velocity v based on the vehicle velocity data b output from the vehicle velocity detecting sensor 14 in order for the determining section 25 to determine whether or not the vehicle is moving (Step S2). If the determining section 25 determines that the vehicle is moving in Step S2, the process proceeds to Step S3. In Step S3, the calculating section 24 calculates the distance l between the vehicle body 1 and the obstacle A based on the obstacle detection data a output from the obstacle detecting sensor 2 and determines the difference between the distance l and a previously calculated distance l′, after which the determining section 25 determines whether or not the distance l and the distance l′ between the vehicle body 1 and the obstacle A are equal. If the determining section 25 determines that these distances are equal to each other in Step S3, the process proceeds to Step S4 in order to add 1 to the calculation number n of the calculating section 24. Then, the process proceeds to Step 5. In Step S5, the determining section 25 determines whether or not the calculation number n has reached 10. If it has not reached 10, the steps subsequent to Step S2 are repeated. In Step S2, if the determining section 25 determines that the vehicle is not moving, and, in Step S5, if the calculation number n of the calculating section 24 has reached 10, there is no danger of colliding, so that the process proceeds to Step S6 in order to set the collision preventing device in a standby state (non-operation state), after which the process returns to Step S2.

In Step S2, if the determining section 25 determines that the vehicle is moving, and, in Step S3, if the determining section 25 determines that the distance l and the distance l′ between the vehicle body 1 and the obstacle A are different, the process proceeds to Step S7. In Step S7, the calculating section 24 determines the difference between the distance l and the threshold distance L stored in the storage section 23 and the determining section 25 determines whether or not the distance l has become equal to the threshold distance L. Then, in Step S7, if the determining section 25 determines that the calculated distance l has become equal to the threshold distance L, the process proceeds to Step S8. In Step S8, desired drive signals c are output to the vibrators 12 based on drive voltage data stored in the storage section 23 and the vibrators 12 are vibrated in order to warn the driver that he is in danger of colliding with the obstacle A.

According to the collision preventing device of the embodiment, in the structure comprising the obstacle detecting sensor 2, vibrators 12, and controller 13 that are disposed at the vehicle, when the obstacle detecting sensor 2 detects the obstacle A and the controller 13 determines that the distance to the obstacle A from the vehicle body 1 has become equal to the previously set threshold distance L, the vibrators 12 are driven in order to exert outside force upon the steering wheel 11 that is a piece of inside equipment. Therefore, regardless of the loudness of noise inside the vehicle, the driver can reliably realize that he has approached the obstacle A, and, thus, reliably prevent the vehicle body 1 from colliding with the obstacle A.

Hereunder, collision preventing devices of other embodiments (second to eighth embodiments) of the present invention will be given.

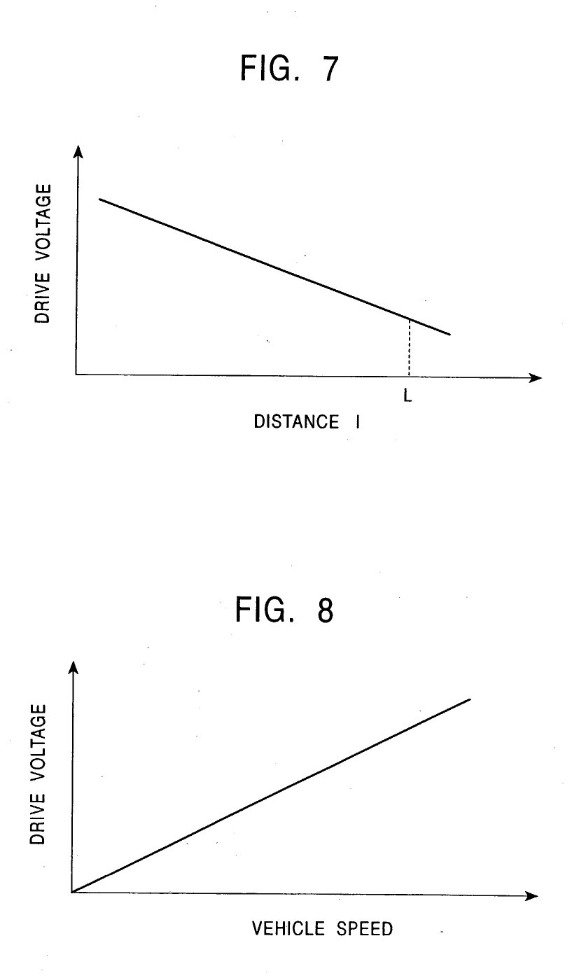

(1) In the first embodiment, if the determining section 25 determines that the calculated distance l has become equal to the threshold distance L, a constant voltage is applied to the vibrators 12. However, the gist of the present invention is not limited thereto. As shown in FIG. 7, when voltage applied to the vibrators 12 is increased as the distance l between the vehicle body 1 and the obstacle A decreases, vibration applied to the steering wheel 11 can be increased. By this, since the driver can realize how close he is to colliding with the obstacle A, he can reliably prevent collision with the obstacle A.

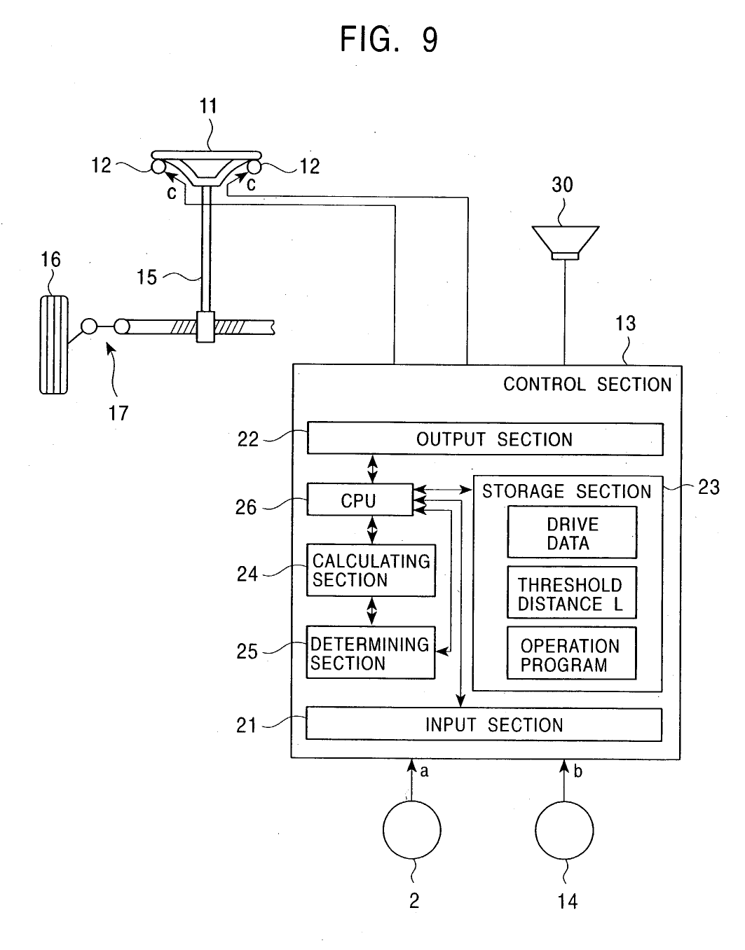

(2) Although, in the first embodiment, a constant voltage or voltages are applied to the vibrators 12 regardless of the vehicle velocity, the gist of the present invention is not limited thereto. As shown in FIG. 8, when voltage applied to the vibrators 12 is increased as the vehicle velocity increases, vibration applied to the steering wheel 11 can be increased. In this case also, since the driver can realize how close he is to colliding with the obstacle A, he can reliably prevent collision with the obstacle A.

(3) Although, in the first embodiment, outside force (vibration) for warning the driver is exerted upon the steering wheel 11, the gist of the present invention is not limited thereto. The same effects can be exhibited by exerting outside force for warning the driver upon any inside equipment, such as the steering shaft 12 or a seat, with which the body of the driver directly or indirectly contacts while he is driving.

(4) Although, in the first embodiment, the vibrators 12 are used as actuators, and the steering wheel 11 is subjected to a constant mode vibration serving as external force for warning the driver, the gist of the present invention is not limited thereto. By using other types of actuators, such as rotary motors, and controlling the driving of the actuators by the controller 13, it is possible to apply various warning forces upon, for example, the steering wheel 11. By this, it is possible to exert various forces upon the driver according to the circumstances, so that the driver can easily know the situation he is in, and, thus, reliably prevent collision with the obstacle A.

(5) Although, in the first embodiment, a structure in which the driver is warned only by force exerted by the vibrators 12 is used, the gist of the present invention is not limited thereto. As shown in FIG. 9, when a speaker 30 is connected to the output section 22, and drive data of the speaker 30 is stored in the storage section 23 of the controller 13, the driver can be warned by both force exerted by the vibrators 12 and sound generated from the speaker 30. By this, the driver can more reliably realize how close he is to colliding with the obstacle A, and, thus, more reliably prevent collision of the vehicle body 1 with the obstacle A.

(6) Although, in the first embodiment, the driving of the actuators (vibrators 12) are controlled only by the distance between the vehicle body 1 and the obstacle A, the gist of the present invention is not limited thereto. The driving of the actuators can be controlled by both the distance between the vehicle body 1 and the obstacle A and the position of the obstacle A with respect to the vehicle body 1. In this case, it is possible to dispose only one actuator and change a drive mode of the actuator in accordance with the location of the obstacle A with respect to the vehicle body 1, or to dispose a plurality of actuators and switch actuators to be driven in accordance with the location of the obstacle A with respect to the vehicle body 1. By this, the driver can know the location of the obstacle A with respect to the vehicle body 1, and, thus, reliably prevent collision of the vehicle body 1 with the obstacle A.

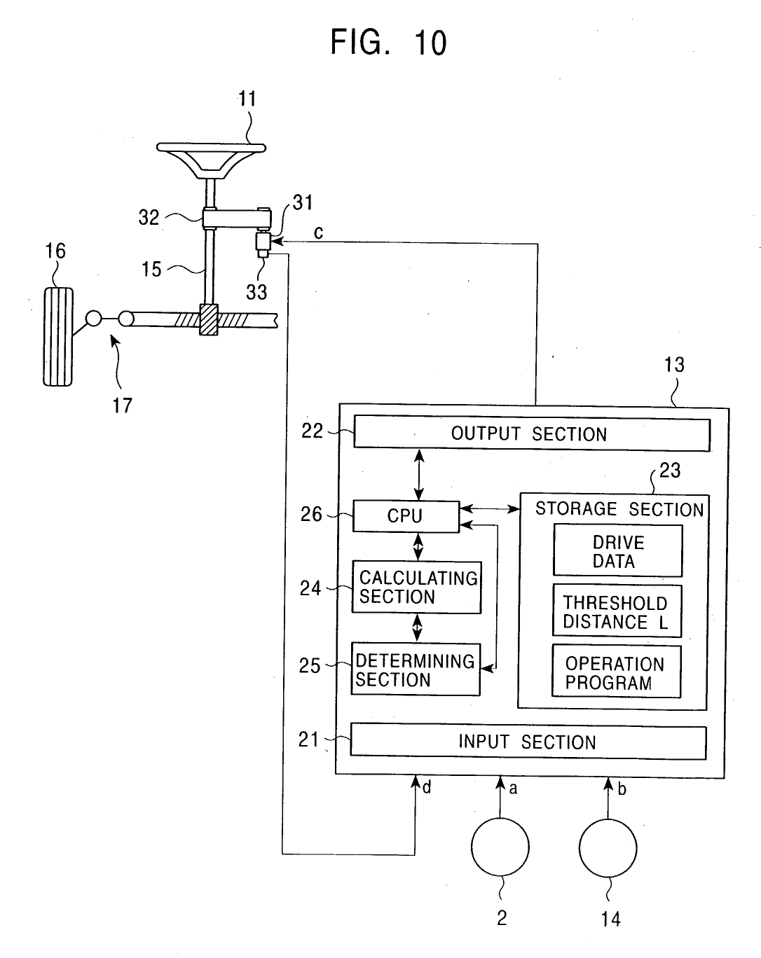

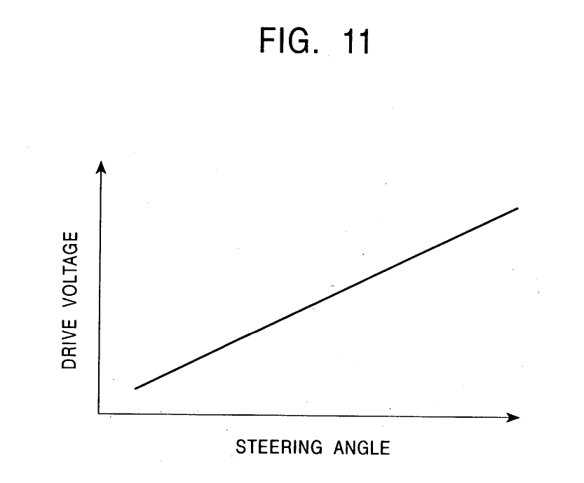

(7) Although, in the first embodiment, outside force for warning the driver is exerted upon a piece of inside equipment (steering wheel 11) by the actuators (vibrators 12), the gist of the present invention is not limited thereto. It is possible to use a structure in which, by controlling rotation of the steering shaft 15, an outside force for directly preventing collision with the obstacle A is directly exerted by the actuators. FIG. 10 shows the structure of a collision preventing device of the eighth embodiment. In the structure, a rotary motor 31, serving as an actuator, is disposed close to the steering shaft 15, the rotary shaft of the rotary motor 31 and the steering shaft 15 are connected together through a desired power transmitting member 32, and a rotary encoder 33, serving as a steering angle detecting sensor, is disposed at the rotary shaft of the rotary motor 31. The rotary encoder 33 is connected to the input section 21 of the controller 13. The storage section 23 of the controller 13 stores drive data (shown in FIG. 11) of the rotary motor 31 that is in accordance with a steering angle signal d output from the rotary encoder 33. In the collision preventing device of this embodiment, when the determining section 25 determines that the distance l between the vehicle body 1 and the obstacle A has become equal to the threshold distance L, and that the obstacle A exists alongside the vehicle body 1, voltage applied to the rotary motor 31 is controlled in accordance with the drive data (shown in FIG. 11) in order to provide resistance to rotation of the steering shaft 15 in the direction in which the vehicle collides with the obstacle A. By this, not only is it possible to exert warning force upon the driver for informing the driver that he is in danger of colliding with the obstacle A, but also it is possible to automatically prevent a dangerous steering operation, so that the driver can reliably prevent collision of the vehicle body 1 with the obstacle A. Although the power transmitting member 31 may be of any type of the related art, it is particularly desirable to use a grooved belt because it is low in cost and can reliably transmit power.

Accordingly, in the structure comprising at least one obstacle detecting sensor, at least one actuator, and control means at the vehicle, when the at least one obstacle detecting sensor detects an obstacle and the control means determines that the distance to the obstacle from the vehicle body has become equal to a previously set threshold distance, the controlling means controls the driving of the at least one actuator. When the controlling operation causes an outside force to be applied to any inside equipment, the driver can realize that he is approaching an obstacle by exerted force. Therefore, regardless of the loudness of the noise inside the vehicle, the driver can reliably realize that he has approached the obstacle, and, thus, reliably prevent collision with the obstacle.

What is claimed is:

1. A collision preventing device for a vehicle, comprising:
at least one obstacle detecting sensor disposed at a vehicle body;
at least one actuator for exerting outside force upon any inside equipment with which the body of a driver contacts when driving; and
controlling means for controlling driving of the at least one actuator,
wherein, when the at least one obstacle detecting sensor detects an obstacle, the controlling means repeatedly calculates the distance between the vehicle body and the obstacle, so that, when the calculated distance between the vehicle body and the obstacle has become equal to a threshold distance previously set in the controlling means, the controlling means drives the at least one actuator to exert the outside force upon the any inside equipment.

2. A collision preventing device for a vehicle according to claim 1, wherein, in accordance with the calculated distance between the vehicle body and the obstacle, the controlling means changes the outside force exerted upon the any inside equipment by the at least one actuator.

3. A collision preventing device for a vehicle according to claim 1, wherein the controlling means determines the position of the obstacle with respect to the vehicle body and, in accordance with the determined position of the obstacle with respect to the vehicle body, changes the outside force exerted upon the any inside equipment by the at least one actuator.

4. A collision preventing device for a vehicle according to claim 1, further comprising a vehicle velocity detecting sensor for detecting the velocity of the vehicle, wherein, based on a velocity signal output from the vehicle velocity detecting sensor, the controlling means changes the outside force exerted upon the any inside equipment by the at least one actuator.

5. A collision preventing device for a vehicle according to claim 1, further comprising a steering angle detecting sensor for detecting the steering angle of a steering wheel, wherein, based on a steering angle signal output from the steering angle detecting sensor, the controlling means changes the outside force exerted upon the any inside equipment by the at least one actuator.

6. A collision preventing device for a vehicle according to claim 1, further comprising a steering angle detecting sensor for detecting the steering angle of a steering wheel and a travel direction detecting sensor for detecting the direction of travel of the vehicle, wherein, based on a steering angle signal output from the steering angle detecting sensor and a travel direction signal output from the travel direction detecting sensor, the controlling means changes the outside force exerted upon the any inside equipment by the at least one actuator.

7. A collision preventing device for a vehicle according to claim 1, wherein the any inside equipment upon which the outside force is exerted by the at least one actuator is any one of a steering shaft, a steering wheel, and a seat.

8. A collision preventing device for a vehicle according to claim 7, wherein the controlling means exerts the outside force upon the steering shaft by driving the at least one actuator in order to resist steering in the direction of the obstacle.

9. A collision preventing device for a vehicle according to claim 7, wherein the controlling means drives the at least one actuator in order to vibrate any one of the steering shaft, the steering wheel, and the seat for warning the driver.

10. A collision preventing device for a vehicle according to claim 1, wherein the at least one obstacle detecting sensor is disposed at a side mirror.

11. A collision preventing device for a vehicle according to claim 1, further comprising a speaker disposed at the vehicle body, wherein, when the at least one obstacle detecting sensor detects the obstacle, the controlling means repeatedly calculates the distance between the vehicle body and the obstacle, so that, when the calculated distance between the vehicle body and the obstacle has become equal to a threshold distance previously set in the controlling means, the controlling means drives the at least one actuator to exert the outside force upon the any inside equipment and drives the speaker to generate a warning sound by the speaker.
